(19) United States
(12) Patent Application Publication
(10) Pub. No.: US 2014/0100902 A1
(43) Pub. Date: Apr. 10, 2014

(54) METHOD AND SYSTEM FOR PERSONAL CUSTOMER SERVICE SOLUTION

(71) Applicant: FUTUREWEI TECHNOLOGIES, INC., Dallas, TX (US)

(72) Inventors: Anna Godfrey, San Jose, CA (US); Joshua D. Moline, San Jose, CA (US); Xiaofeng Jin, Santa Cruz, CA (US)

(73) Assignee: Futurewei Technologies, Inc., Dallas, TX (US)

(21) Appl. No.: 13/647,765

(22) Filed: Oct. 9, 2012

(51) Int. Cl. G06Q 10/06

(52) U.S. Cl. 705/7.13

(57) ABSTRACT

A method for engaging personalized customer services on an end-user device includes sending a request for agent-assisted service to the agent administration server, and receiving from the agent administration server agent information associated with a plurality of customer agents. The agent information defines agent identification information, an agent availability status, and one or more agent communication channels. The method further includes sending a request to communicate with a preferred one agent from the plurality of customer agents. The request includes at least one desired communication channel from the one or more agent communication channels. The desired communication channel is then established with the preferred one agent.

### FIELD OF THE TECHNOLOGY

The present application relates to the field of communication technology, and more particularly to establishing communication with a preferred service agent through multiple communication channels.

### BACKGROUND

As the world is moving towards a service-oriented economy from a manufacturing-oriented economy, satisfying customer service will be a key deciding factor for all businesses. More and more consumers rely on communication devices such as desktop computers, laptop computers, tablets, smart phones or other networked devices to access the internet to research information for products, services, to make inquiries, or when making a purchase in response to an advertisement.

For example, an end-user such as a customer in response to seeing a travel agency's advertisement promotion in an email, may call a travel agency using a smart phone to request assistance in making a plane ticket reservation, car rental reservation, hotel reservation, and/or tour package arrangement. However, the customer does not have any control over whom he or she would encounter when communicating to a customer service representative. If a particular customer service representative is rude or has a history of receiving many unreported complaints by prior customers, it is likely that the same particular customer service representative would cause an unpleasant experience or poorly serve the next customer, which may result in a lost business opportunity.

### SUMMARY

In a first aspect, a method for engaging personalized customer services on an end-user device includes sending a request for agent-assisted service to the agent administration server, and receiving from the agent administration server agent information associated with a plurality of customer agents. The agent information defines agent identification information, an agent availability status, and one or more agent communication channels. The method further includes sending a request to communicate with a preferred one agent from the plurality of customer agents. The request includes at least one desired communication channel from the one or more agent communication channels. The desired communication channel is then established with the preferred one agent.

In a second aspect, a method for engaging personalized customer services includes receiving, at an agent administration server, a request for agent-assisted service, and selecting, by the agent administration server and from an agent administration database, agent information for a plurality of customer agents. The agent information defines agent identification information, an agent availability status, and one or more agent communication channels. Agent information associated with at least some of the customer agents is communicated to an end-user device. The method further includes receiving, at the agent administration server, a request from the end-user device to communicate with a preferred agent. The request includes at least one desired communication channel from the agent communication channels. The agent administration server establishes the desired communication channel between the end-user device and the preferred one agent.

In a third aspect, a non-transitory computer readable medium includes computer program codes executable by one or more processor for engaging personalized customer services. The computer program code causes an agent administration server to receive a request for agent-assisted service and select agent information for a plurality of customer agents. The agent information defines agent identification information, an agent availability status, and one or more agent communication channels. Agent information associated with at least some of the customer agents is communicated to an end-user device. A request is received from the end-user device to communicate with a preferred agent. The request includes at least one desired communication channel from the one or more agent communication channels. The desired communication channel is established between the end-user device and the preferred one agent.

### BRIEF DESCRIPTION OF THE DRAWINGS

The accompanying drawings are included to provide a further understanding of the claims, are incorporated in, and constitute a part of this specification. The detailed description and illustrated embodiments described serve to explain the principles defined by the claims.

FIG. 1 depicts a network environment according to an embodiment;

FIG. 2 depicts a system diagram of FIG. 1 according to an embodiment;

FIGS. 3A to 3C depict multi-channel communications between an end-user device and the preferred one customer agent according to an embodiment;

FIG. 4 depicts an exemplary screen shot of the customer agent dashboard web service according to an embodiment;

FIG. 5 depicts another screen shot of the customer agent dashboard web service according to an embodiment;

FIG. 6 is a flow chart, which depicts exemplary steps for engaging personalized customer services on the end-user device, according to an embodiment of the present invention; and

FIG. 7 is a flow chart which depicts exemplary steps for engaging personalized customer services on the agent administrator server, according to an embodiment of the present invention.

### DETAILED DESCRIPTION OF THE EMBODIMENTS

The problems described above are overcome by providing a system for engaging personalized customer services that enhance customer service satisfaction. The system enables an end-user to have control over the selection of a customer service agent when requiring customer service.

For example, one embodiment herein described provides terminal or end user customers with an application or interface providing a social networking piece to a service or customer support from a sales or service representative or agent. In other words, one embodiment empowers the customer with the visibility of all available customer service agent or sales representatives (sorted, e.g., by ranking, experience, positive feedback, etc.). Current customer support and service representative systems do not expose customer agent identities to customer; thus, lacking the social aspect to a needed service industry. By providing the customer with the visibility of the support or customer agents' working identity advantageously provides enhanced customer experience and accountability for the service agents or sales representatives.

In other embodiments, methods, systems, apparatuses, and computer program products provide customers with the ability to select from multiple channels of contact for a customer agent they choose. For example, the customer agent or representative may be available for contact through instant messaging systems (IMS), text messaging, video conferencing, voice lines, web conferencing, email, or any number of other communication forms. These may be presented for the user as available options of communication, which the customer can then select one or more thereof as appropriate.

In another embodiment, a social ranking and personal preference setting about customer agents or representatives is gathered, sorted, and stored for various other embodiments. For example, one embodiment allows a customer to tag a favorite customer agent, or add poor customer agent into black list, good customer agents to a white list, rank the customer agent on a sliding scale, add comments about the customer agent, etc.

Of course, other embodiments consider the advantageous features of the present invention also empower the service provider or customer agent with a centralized view of customer message stream. Such messages may be prioritized, sorted, and filtered as necessary to meet the service providers specific needs. Furthermore, customer agents can tag a customer for follow up, respond to customer ratings, provided targeted out-reach or status of service, etc.

In another embodiment, the customer agent may list and specify preferred forms of communication with a customer one-on-one through, e.g., audio, video, email, IM, Text. Similarly, a customer agent or service representative can specify available or preferred forms of communicates with customers by one-to-many through, e.g., status updates.

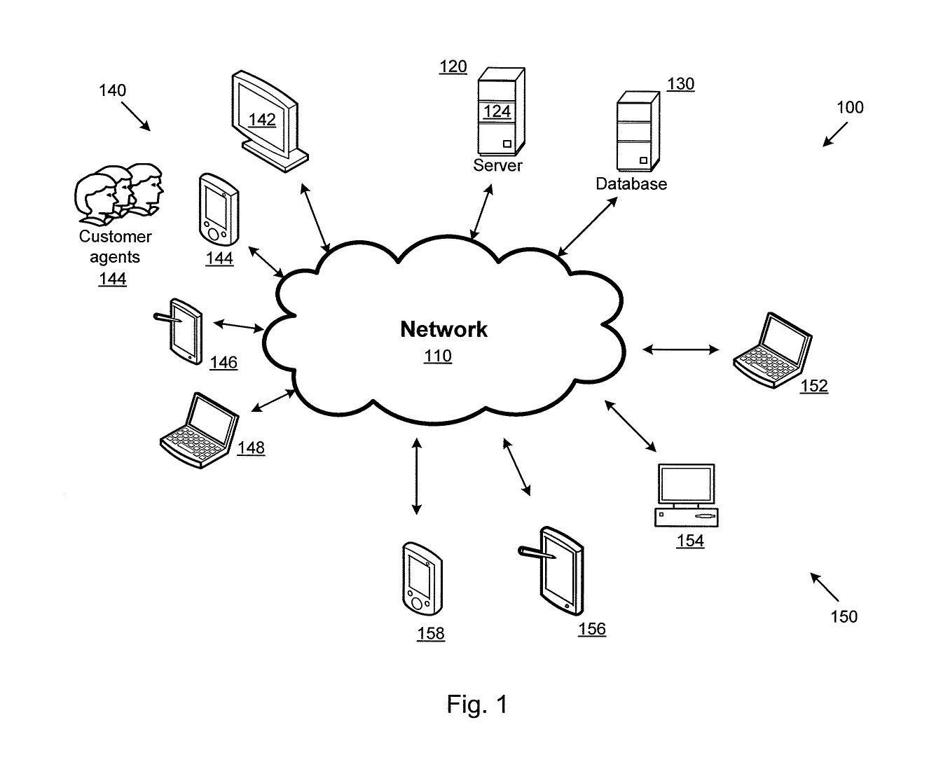

FIG. 1 depicts a network environment (100) according to an embodiment. More specifically, the network (110) may be formed by a combination of existing wired and wireless hybrid network infrastructure interconnected together. The network (110) may operate in various technologies to support multi-channel communication formats such as voice, text and video.

In an embodiment, an end-user device (150) may communicate to the network (110) to request agent-assisted service from a business entity (140). The end-user device (150) may be any communication device with access to the network (110), such as a smart phone (158), a communication tablet device (156), a laptop computing device (152), a computer (154), a personal digital assistant (PDA) device, or a different communication device.

The business entity (140) may employ a plurality of customer agents (144) each using an agent dashboard web service (142) to communicate with an end-user through multiple channels of communication over the network (110). Alternately, the plurality of customer agents (144) may use any communication device with access to the network (110), such as a smart phone (144), a communication tablet device (146), a laptop computing device (148), or a different communication device to communicate with the end-user device (150).

For example, a business entity (140), such as a travel agency or an airline, may utilize a legacy call center solution application, which runs on an agent administration server (120) to facilitate customer service over the network (110). In an embodiment, the agent administration server (120) may be part of a cloud computing infrastructure remotely located from both the customer agents (144) and the end-user device (150), and may access information to conduct business from a local or remote network database (130). The database (130) may store a wide range of secured data collected by one or more business entities (140), such as an agent's information, and/or customer information, to name a few.

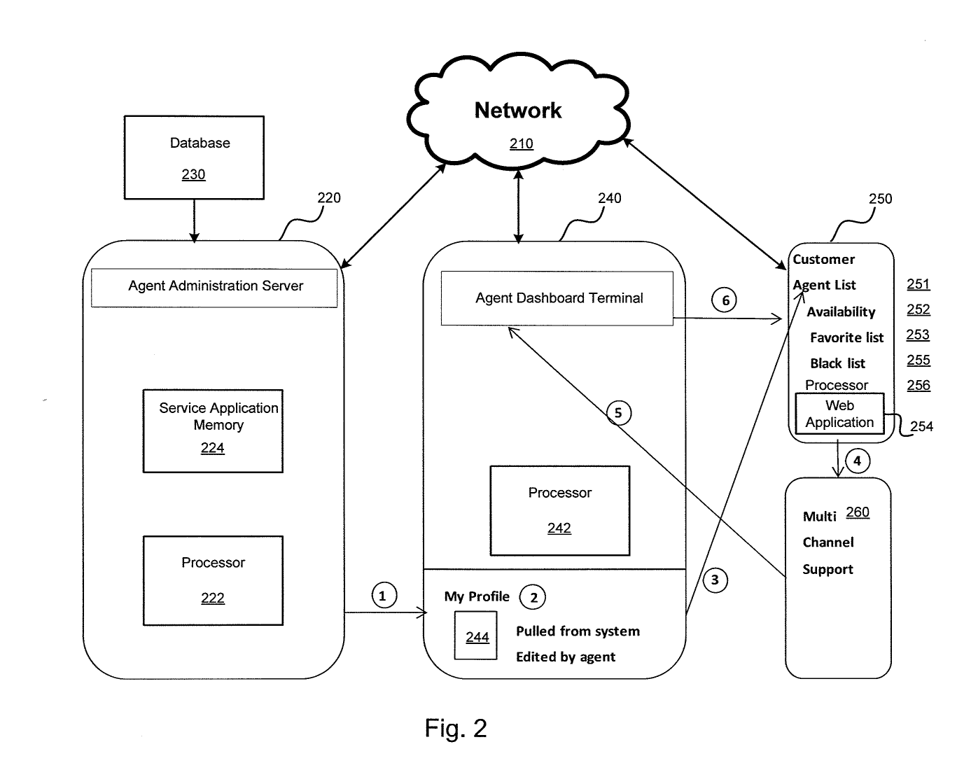

FIG. 2 depicts an exemplary system diagram of FIG. 1 according to an embodiment, where a service application (224) may be installed in and executed by an agent administrator server (220) to facilitate a legacy call center solution to assist customers. In a scenario, the following exemplary operations may take place:

In operation (1), a plurality of customer agents working for a business entity may each log in through an agent dashboard web service (240) to the network (210) to connect to the agent administration server (220) and download their agent information, such as profile information from a database (230).

In operation (2), the customer agents may each edit their profile information (244) at any time, for example, to post their mood or personal highlights of the day, to set their profile to be visible or invisible to the customer, and their availability. The updated profile information is then stored in the database (230) as updated agent information (244).

In operation (3), a customer (i.e., an end-user) may launch a web application (254) on an end-user device (250) (such as a smart phone) to connect to the web service through the network (210) to request agent-assisted service. The agent administrator server (220) may pass the updated agent information (244) to the web application (254) on the end-user device (250). Afterwards, the end-user device (250) may display a customer agent list (251), which is a list of customer agents with agent information (244) that defines one or more of, e.g., agent identification information, availability status, and/or agent communication channels. Of course, other types of information may be provided to assist in easily identifying, selecting, and connecting to a customer agent; and thus, the mentioned types of agent identification information is used herein is for illustrative purposes only and is not meant to limit or otherwise narrow the scope of the present invention unless otherwise explicitly claimed.

More specifically, the agent identification information may include an agent's updated profile information, such as a brief description of the agent, a picture, birth place, business address, county or state of residence, affiliated social networks, area of expertise, education background, curriculum vita, hobbies, moods or highlights of the day, or other information. In an example embodiment, the agent information may also include the agent's time or schedule availability (252) (used, e.g., if the agent is busy with another customer or shows his/her vacation schedule, normal operating hours, that they are on a break, etc.). Still another embodiment also provides a customer agent's service rating or service ranking by the customers, peers, work performance, awards, or other measures of customer service or job performance. In other words, the customer agent list (251), with the associated agent information (244), provides the customer with information that enables the customer to make an informed decision as to the selection of an agent and enables the customer to have certain control over his or her experience when being served or otherwise assisted, which provides many of the aforementioned advantages over known systems that lack these capabilities.

In operation (4), after viewing the customer agent list (251) and the associated agent information (244), the customer may select a preferred customer agent who is available to communicate with the customer through one or more agent communication channels. For example, the preferred customer agent may be available to communicate with the customer by voice through, e.g., a land line, cell number, Voice over IP (VoIP) connection, or other voice channel. In another embodiment, the preferred customer agent may be available to communicate with the customer by chat messages in a service forum, or via instant text messaging services (e.g., IMS). In another embodiment, the preferred customer agent may be available to communicate with the customer via multi-channel communication format, such as a live video feed. In yet another embodiment, the preferred customer agent may be available to communicate offline via email messaging, or some other format. Of course, any combination of the above communications is also contemplated herein and any specific use, selection, display, or other available communication channel for the customer agent is used herein for illustrative purposes and is not meant to limit or otherwise narrow the scope of the present invention unless otherwise claimed.

If the preferred customer agent is not available, the customer may be provided with an estimated waiting time. The customer may have a choice to wait for his or her turn to be served by the preferred customer agent, or send a service request to be contacted when the preferred agent becomes available, or may select a next-preferred customer agent from the customer agent list (251). Of course, other measures of customer agent availability may be displayed depending on the amount of visibility desired. For instance, the agents work, vacation, break, or other schedule may be displayed to allow the customer the optimum ability to contact the agent during operating hours. Alternatively, or in conjunction, a display of the average wait time, peak hours, off peak hours, or other indicators that allow for optimal chance for contacting the agent or representative are also contemplated herein.

In operation (5), the customer agent may view his or her agent dashboard or web service (240) to find out the next customer waiting in, e.g., in a centralized queue, and to communicate with the customer in one or more channel communications.

In operation (6), the customer agent may strive to provide a quality and personal service to the customer in order to earn approval or a high rating/ranking from the customer. The customer may accordingly rate the preferred customer agent based on the service experience he or she has received from the preferred customer agent.

In addition, the preferred customer agent may be added to the end-user's favorite list (253), which may be stored in the database (230) under both a customer's profile information and under the agent's information. In this regard, for future service, the same customer may be prompted by tagging the same preferred customer agent (assuming he or she is available at the time) to render new service to the customer, thus saving some of the customer's time and building customer loyalty. Furthermore, the customer agent may tag the customer for follow up future promotion sales, thus increasing sales from loyal customers. Accordingly, the customer agent may be rewarded based on his or her consistent rating or ranking feedback by the customer, and based on a frequency of return business from the loyal customers.

On the contrary, if the customer has an unhappy service experience with a customer agent, the customer may provide a low rating or ranking for the customer agent as feedback. In addition, the customer may add the undesirable customer agent to a black list, or a desirable one to a white list. In this regard, for future service, the same undesirable customer agent would not appear or may be blocked from the customer agent list when the same customer requests new service, whereas the agents in the white list may appear. Accordingly, the less desirable customer agent may be disciplined based on a consistently low rating or ranking feedback by the customer, and likewise favorable customer ratings will allow for just appraisal and compensation. Of course, other forms of customer feedback and ratings are also contemplated herein. For instance, there may also be an area with customer comments or other information to assist customers in making an appropriate selection. As such, the aforementioned and following social or customer ratings are used herein for illustrative purposes and is not meant to limit or otherwise narrow the scope of the present invention unless otherwise explicitly claimed.

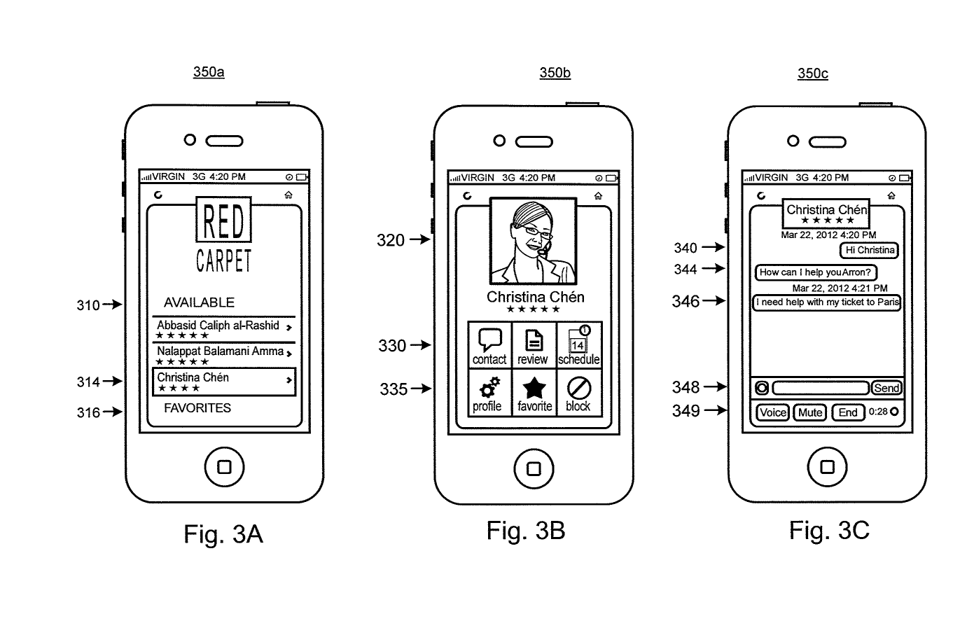

FIGS. 3A to 3C depict multi-channel communications between an end-user device and a preferred customer agent according to an embodiment. More specifically, FIGS. 3A to 3C illustrate exemplary screen shots (350a to 350c) of what an end-user device may display after launching a web application to connect to the agent administration server (220) through the network (210), as described in FIG. 2.

For example, FIG. 3A illustrates a screen shot (350a) on an end-user device, which displays agent information (310), such as the names of the available customer agents (i.e., Abbasid, Nalapat and Christina Chen, etc.). In addition, the rating of each customer agent may also be represented by a number of stars located directly beneath a respective agent's name. In this example, more stars under the name indicate a higher rating by customers. In another embodiment, the available customer agents (i.e., Abbasid, Nalapat and Christina Chen, etc.) may be the names of the preferred customer agents from past service inquiries made by the customer, which may be tagged from the end-user's “favorites” folder (316). Of course, other agent information and ratings as described herein is also contemplated; and thus, the displayed interface in FIG. 3A (as well as other graphical user interfaces and other displays) is for illustrative purposes only and is not meant to limit or otherwise narrow the scope of embodiments described herein unless otherwise explicitly claimed.

In FIG. 3B, the customer may select the profile button (335) to view the profile picture of a preferred customer agent (320) (i.e., Christina Chen). The customer may also select a communication channel button (330) to establish communication with the preferred customer agent (320). FIG. 3C illustrates chat messages (340 to 346) or text format communications that are exchanged between the end-user device and the preferred customer agent (320). FIG. 3C also illustrates that voice (348) and video (349) may be initiated or added during the communication session. Of course, other forms, types, and combinations of communication channels are contemplated herein; and thus, the displayed communication channels herein are for illustrative purposes only and are not meant to limit or otherwise narrow the scope of embodiments described herein unless otherwise explicitly claimed.

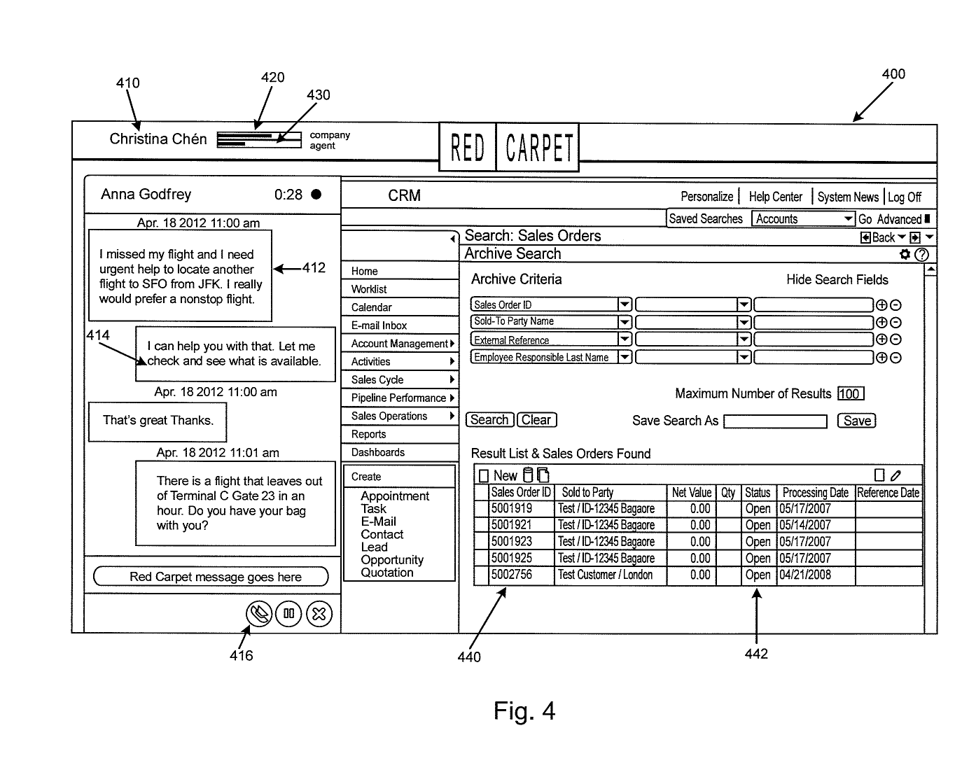

FIG. 4 depicts an example screen shot of a customer agent dashboard or web service according to an example embodiment. For instance, the preferred customer agent's name (410) (i.e., Christina Chen) may be shown on the agent dashboard web service (400) as the next customer to be served in a queue (preferably a centralized queue. In an embodiment, the customer may prefer to send a chat message (412) to the preferred customer agent. In return, the customer agent may answer the customer by sending a corresponding chat message (414). Alternately, the preferred customer agent may communicate with the customer by voice format. For example, the customer agent may answer a voice over IP (VOIP) call by clicking on the phone call button (416) to talk to the customer. Of course, any other various forms of communication listed herein and otherwise known is contemplated herein as described.

The agent dashboard or web service (400) may be configured by the service application (224) of FIG. 2 to display, e.g., the cumulative service feedback rating (420) from the customer, and an overall service ranking of the agent within the business organization. This advantageously provides for instant customer feedback; thus, allowing the agent with real-time results to easily identify conduct or performance that is either effective or ineffective. In other words, the quick or almost instant feedback allows the agent to easily identify good and bad conduct or habits and adjust their behavior or performance accordingly.

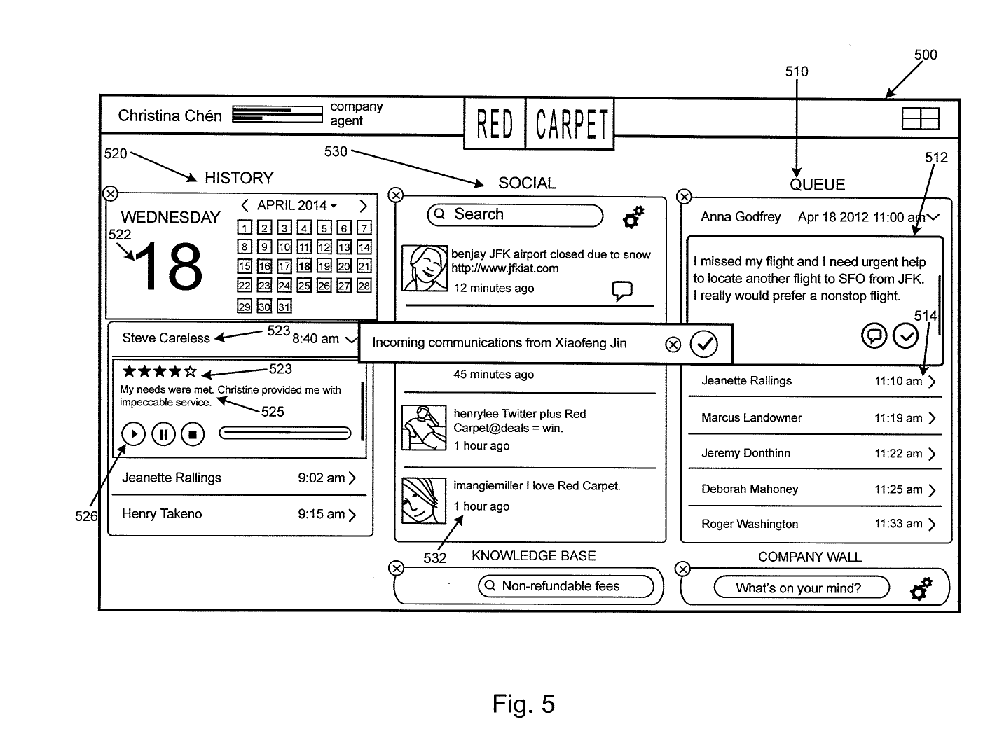

FIG. 5 depicts another example screen shot of the agent dashboard or web service (500) according to an embodiment. For example, the agent dashboard or web service (500) may be configured by the service application (224) of FIG. 2 to display a queue (510) of the customers who are waiting to be served. More specifically, the customer agent may be serving a current customer (512) via a chat message. Another customer (514) in the queue may have requested to be served via video conferencing and may be willing to wait for a customer-specified number of minutes for this communication channel to become available.

In addition, the agent dashboard or web service (500) may be configured to retrieve a saved history record (520) of the agent's past communication with customers from a database. The history record (520) may be based on a calendar date and time (522), a name of the customer (523), corresponding content of the chat messages (525) or voice recording (526), along with a feedback rating (523). Such saved history record (520) may serve as evidence in case of a potential dispute with a customer's claim, or may be used for customer agent training purposes or for performance rating verification.

Alternately, or in conjunction, the customer agent's feedback rating may be linked to a social network (530) such as Facebook, Twitter, Fanbox, Myspace, or a review network such as Yelp, etc., where a customer (532) may leave feedback comments or blogs to their public accounts to reflect their experience of satisfaction or dissatisfaction with the business products or service, or with the service agent's service.

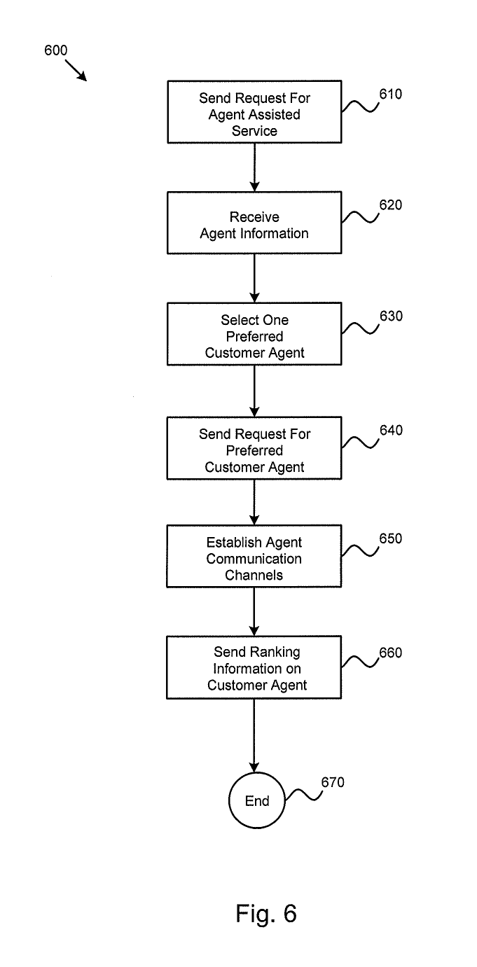

FIG. 6 is a flow chart, which depicts exemplary steps for engaging personalized customer services on an end-user device, according to an example embodiment. More specifically, the operations performed in FIG. 6 may be performed by at least one processor within the end-user device (250) of FIG. 2.

In block (610), the end-user device may send a request for agent-assisted service to a business web service. More specifically, block (610) may be performed between a web application (254) that operates on the end-user's device (250) and a service application (224) that operates on the agent administrator server (220) in the network (210).

In block (620), the end-user device may receive agent information from the agent administrator server (220), which may be imported from the database (230).

In block (630), the customer may review the agent information in a provided list, such as the profile information of the customer agents, their availability (i.e., whether waiting required), and the available form of the communication channel (e.g., text, voice or video) for communicating with the agent.

In block (640), the end-user device may send a request for service from a preferred customer agent. More specifically, the requested selection may be based on review of the agent's information and/or the availability, or be automatically tagged by a favorite list of agents saved from a prior service.

In block (650), the end-user device may be connected to the agent dashboard web service (240) of the preferred customer agent according to the requested form of communication channel, which may be text, voice or video format, or any combination thereof.

In block (660), after the customer agent has completed the agent-assisted service with the customer, the customer may send a satisfaction feedback rating to rate the customer agent for the customer's service experience.

In block 670, the database (230) may store the feedback rating into the customer agent's database for performance review. The feedback rating may be useful for the business in that it may allow that business to improve competitiveness in the services and/or products offered, and/or to facilitate improved training of customer service agents.

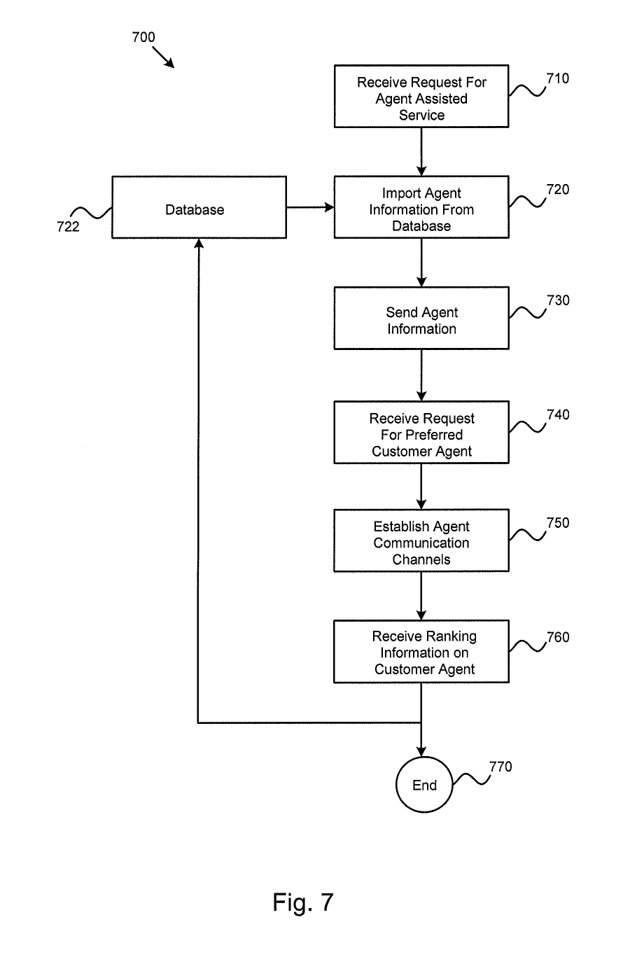

FIG. 7 is a flow chart, which depicts exemplary operations for engaging personalized customer services on the agent administrator server, according to an embodiment. More specifically, the steps performed in FIG. 7 may be performed by one or more processors within the agent administrator server (220) of FIG. 2.

In block (710), a service application (224) on the agent administrator server (220) in the network (210) may receive a request for agent-assisted service from an end-user device. More specifically, block (710) may be performed between a web application (254) on the end-user's device (250) and a service application (224) on the agent administrator server (220) in the network (210).

In block (720), the agent administrator server (220) may query the agent dashboard web service (240) and determine the availability of customer agents. The agent administrator server (220) may import from the database (230) a list of customer agents along with associated agent information.

In block (730), the agent administrator server (220) may communicate to the end-user device with a list of the customer agents, along with the agent information. For example, the profile information of the customer agents, their availability, and the available form of communication channel with the agent may be communicated.

In block (740), the agent administrator server (220) may receive from the end-user device a request for service from a preferred customer agent. More specifically, the request selection may be based on review of the agent's information and/or the availability, or be automatically tagged by a favorite list of agents saved from a prior service.

In block (750), the agent administrator server (220) may establish a communication channel between the end-user device and the agent dashboard web service (240) of the preferred customer agent according to the requested form of communication channel, which may be text, voice or video format, or any combination thereof.

In block (760), after the customer agent has completed the agent-assisted service with the customer, the agent administrator server (220) may receive from the customer a satisfaction feedback rating to rate the customer agent for the customer's service experience.

In block (722), the database (230) may store the feedback rating into the customer agent's database for performance review. The feedback rating may be useful for the business to improve competitiveness in services and products offered, and may be used in providing training to the customer service agents so as to allow the customer service agents to better serve their customers.

As described, the system for engaging personalized customer services improves the customer support experience and service efficiency to the customers. In addition, the invention transforms a “faceless” or “black hole” customer service experience into a personal service level, which enables the business to engage its customers through better customer experience. In addition, the benefits of the proposed method and system may improve customer loyalty and elevate the business competitiveness.

Those of ordinary skill in the art should understand that all or a part of the steps in the method according to the embodiments of the present invention can be implemented by a program instructing relevant hardware, and the program may be stored in a non-transitory computer readable storage medium, such as a ROM/RAM, a magnetic disk, or an optical disk, which are executed in a machine, such as an end-user mobile device, in a server, or cloud computing infrastructure.

It will be apparent to those skilled in the art that various modifications and variations can be made to the present invention without departing from the scope or spirit of the invention. In view of the foregoing, it is intended that the present invention cover modifications and variations of this invention provided they fall within the scope of the following claims and their equivalents.

What is claimed is:

1. In an end-user device, a method for engaging personalized customer services by providing an interface for selecting a customer service agent based on at least one of a social aspect, agent availability status, or available communication channels, the method comprising:
sending a request for agent-assisted service to an agent administration server;
receiving, from the agent administration server, agent information associated with a plurality of customer agents, wherein the agent information includes one or more of agent identification information, an agent availability status, and one or more agent communication channels;
based on the received agent information associated with the plurality of customer agents, displaying the agent information for at least one of the plurality of customer agents;
receiving user input from the interface, a selection of a preferred agent from the at least one of the plurality of customer agents;
based on the received user input, sending to the agent administration server a request to communicate with the preferred agent; and
establishing the desired communication channel with the preferred agent.

2. The method according to claim 1, wherein the request includes at least one desired communication channel from the one or more agent communication channels.

3. The method according to claim 2, wherein the at least one desired communication channel supports one or more of voice, text or video format communication.

4. The method according to claim 1, wherein the agent information comprises at least one of: agent's biographical information, profile picture, social network affiliation, areas of expertise or skills, customers' rated comments and performance ranking.

5. The method according to claim 1, comprising accessing the agent administration server via a web application that operates on the end-user device.

6. The method according to claim 1, comprising communicating service satisfaction ranking information of the requested one agent based on end-user's feedback.

7. The method according to claim 1, comprising importing agent information from at least one of: an agent administrator database, a social network database or uploading from agent's communication device.

8. The method according to claim 1, wherein the end-user device comprises at least one of: a mobile wireless communication device, a smart phone, a personal digital assistant (PDA) device, a communication tablet device, a laptop computing device or a communication device connected to a network.

9. A method for engaging personalized customer services by providing an interface for selecting a customer service agent based on at least one of a social aspect, agent availability status, or available communication channels, the method comprising:
receiving, at an agent administration server, a request from an end-user device for agent-assisted service;
selecting, by the agent administration server and from an agent administration database, agent information for a plurality of customer agents, wherein the agent information includes agent identification information, an agent availability status, and one or more agent communication channels;
communicating agent information associated with at least some of the plurality of customer agents to the end-user device;
receiving at the agent administration server, a request based on a user input from the interface of the end-user device to communicate with a preferred agent from the plurality of customer agents, wherein the request includes at least one desired communication channel from the one or more agent communication channels;
establishing, by the agent administration server, the at least one desired communication channel between the end-user device and the preferred one agent.

10. The method according to claim 9, wherein the request includes at least one desired communication channel from the one or more agent communication channels.

11. The method according to claim 10, wherein the at least one desired communication channel supports one or more of voice, text or video format communication.

12. The method according to claim 9, wherein the agent information comprises at least one of: agent's biographical information, profile picture, social network affiliation, areas of expertise or skills, customers' rated comments and performance ranking.

13. The method according to claim 9, comprising accessing the agent administration server via a web application that operates on the end-user device.

14. The method according to claim 9, comprising communicating service satisfaction ranking information of the requested one agent based on end-user's feedback.

15. The method according to claim 9, comprising importing agent information from at least one of: the agent administrator database, a social network database or uploading from agent's communication device.

16. The method according to claim 9, wherein the end-user device comprises at least one of: a mobile wireless communication device, a smart phone, a personal digital assistant (PDA) device, a communication tablet device, a laptop computing device or a communication device connected to a network.

17. A non-transitory computer readable medium, comprising computer program codes stored thereon, executable by one or more processors in an agent administration server for engaging personalized customer services by providing an interface for selecting a customer service agent based on at least one of a social aspect, agent availability status, or available communication channels, wherein the computer program codes are executed to perform functions, comprising:
receiving a request for agent-assisted service;
selecting, from an agent administration database, agent information for a plurality of customer agents, wherein the agent information includes agent identification information, an agent availability status, and one or more agent communication channels;
communicating agent information associated with at least some of the plurality of customer agents to an end-user device;
receiving a request based on a user input from the interface of the end-user device to communicate with a preferred agent from the plurality of customer agents, wherein the request includes at least one desired communication channel from the one or more agent communication channels;
establishing the at least one desired communication channel between the end-user device and the preferred one agent.

18. The non-transitory computer readable medium according to claim 17, wherein the request includes at least one desired communication channel from the one or more agent communication channels.

19. The non-transitory computer readable medium according to claim 18, wherein the at least one desired communication channel supports one or more of voice, text or video format communication.

20. The non-transitory computer readable medium according to claim 17, wherein the agent information comprises at least one of: agent's biographical information, profile picture, social network affiliation, areas of expertise or skills, customers' rated comments and performance ranking.

21. The non-transitory computer readable medium according to claim 17, comprising accessing the agent administration server via a web application that operates on the end-user device.

22. The non-transitory computer readable medium according to claim 17, comprising communicating service satisfaction ranking information of the requested one agent based on end-user's feedback.

23. The non-transitory computer readable medium according to claim 17, comprising importing agent information from at least one of: the agent administrator database, a social network database or uploading from agent's communication device.
